(19) United States
(12) Patent Application Publication
(10) Pub. No.: US 2005/0280680 A1
(43) Pub. Date: Dec. 22, 2005

(54) Air management in a fluid ejection device

(76) Inventors: Jeffrey S. Hess, Corvallis, OR (US); Philip H. Harding, Albany, OR (US); Manish Giri, Corvallis, OR (US); Gilbert G. Smith, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/872,215

(22) Filed: Jun. 18, 2004

(51) Int. Cl. B41J 2/19

(52) U.S. Cl. 347/92

(57) ABSTRACT

One exemplary fluid ejection device includes a substrate having one or more layers positioned thereon. The fluid ejection device also includes a fluid-feed path extending through a space which is defined, at least in part, by the one or more layers. The fluid ejection device including methods and structures for managing air and amongst other things gas bubble formation.

### BACKGROUND

Air in the form of bubbles can be present in various fluid ejection devices, such as print heads. In some fluid ejection devices bubbles can reduce and/or occlude fluid flow and cause the device to malfunction. Management of the air bubbles can enhance the performance and reliability of the fluid ejection device

### BRIEF DESCRIPTION OF THE DRAWINGS

The same components are used throughout the drawings to reference like features and components wherever possible. Alphabetic suffixes are utilized where appropriate to distinguish different embodiments. The diagrammatic representations illustrated herein are for illustrative purposes and may not be to scale.

FIG. 1 illustrates a front elevational view of an exemplary printer in accordance with one embodiment.

FIG. 2 illustrates a perspective view of an exemplary print cartridge in accordance with one embodiment.

FIG. 3 illustrates a cross-sectional view of a portion of an exemplary print head as shown in FIG. 2 in accordance with one embodiment.

FIGS. 4a, 4c, 4e, 4g, 4i, 4k, 4m, and 4o illustrate an enlarged cross-sectional view of a portion of the exemplary fluid ejection device shown in FIG. 3 in accordance with one embodiment.

FIGS. 4b, 4d, 4f, 4h, 4j, 4l, and 4n illustrate top views of a portion of the fluid ejection device shown in FIGS. 4a, 4c, 4e, 4g, 4i, 4k, and 4m, respectively in accordance with one embodiment.

FIG. 5a illustrates a cut-away perspective view of a portion of another exemplary fluid ejection device in accordance with one embodiment.

FIG. 5b illustrates a cross-sectional view of a portion of the exemplary fluid ejection device illustrated in FIG. 5a in accordance with one embodiment.

FIG. 5c illustrates a top view of a portion of the exemplary fluid ejection device illustrated in FIG. 5a in accordance with one embodiment.

FIG. 5d illustrates a cut-away perspective view of a portion of another exemplary fluid ejection device in accordance with another embodiment.

FIG. 5e illustrates a cross-sectional view of a portion of the exemplary fluid ejection device illustrated in FIG. 5d in accordance with another embodiment.

FIG. 5f illustrates a top view of a portion of the exemplary fluid ejection device illustrated in FIG. 5d in accordance with another embodiment.

FIG. 5g illustrates a cut-away perspective view of a portion of another exemplary fluid ejection device in accordance with an additional embodiment.

FIG. 5h illustrates a cross-sectional view of a portion of the exemplary fluid ejection device illustrated in FIG. 5g in accordance with an additional embodiment.

FIG. 5i illustrates a top view of a portion of the exemplary fluid ejection device illustrated in FIG. 5g in accordance with an additional embodiment.

FIG. 6 illustrates an enlarged cross-sectional view of a portion of another exemplary fluid ejection device in accordance with one embodiment.

FIG. 6a illustrates a top view of a portion of the embodiment of the exemplary fluid ejection device shown in FIG. 6.

FIG. 6b illustrates a top view of an alternative configuration of a portion of the embodiment of the exemplary fluid ejection device shown in FIG. 6.

FIG. 7 illustrates a top view of a portion of another exemplary fluid ejection device in accordance with one embodiment.

FIG. 7a illustrates an enlarged top view of a portion of the embodiment of the exemplary fluid ejection device shown in FIG. 7 in accordance with one embodiment.

FIG. 8 illustrates a top view of a portion of another exemplary fluid ejection device in accordance with one embodiment.

### DETAILED DESCRIPTION

The embodiments described below pertain to methods and systems related to fluid ejection devices such as print heads. As such, the term “ink” will be used in the following description, but other fluids are utilized in suitable embodiments.

Among other origins air in the form of bubbles may be formed in the ink as a byproduct of operation of a printing device. For example bubbles may be formed as a byproduct of the ejection process in the printing device's print cartridge when ink is ejected from one or more chambers.

If bubbles accumulate within the fluid ejection device, e.g. print head, the bubbles may occlude ink flow to some or all of the chambers and may cause the fluid ejection device to malfunction. Some embodiments provide structures and methods that may purge air and/or bubbles from the fluid ejection device to decrease the likelihood of such a malfunction as will become apparent below.

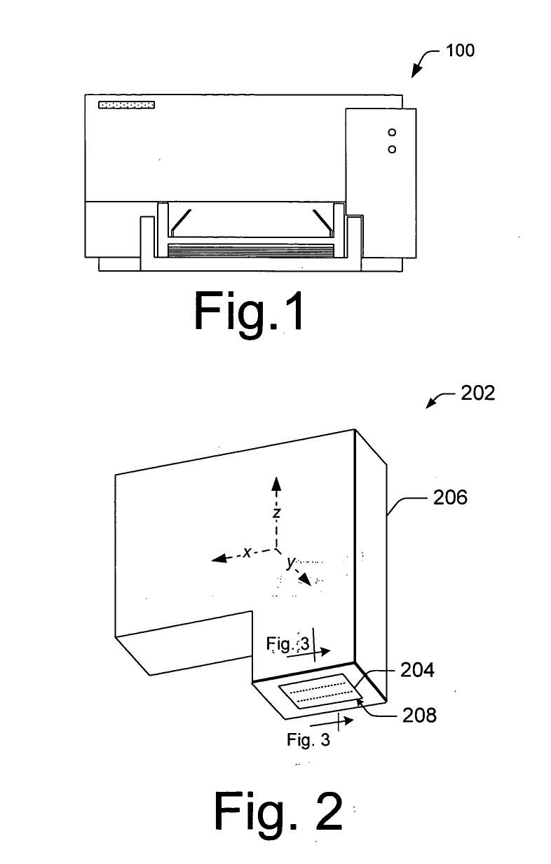

FIG. 1 shows an exemplary printing device in accordance with one embodiment. In this embodiment the printing device comprises a printer 100. The printer shown here is embodied in the form of an inkjet printer. The printer 100 may be capable of printing in black-and-white and/or color. The term “printing device” refers to any type of printing device and/or image forming device that employs a fluid ejection device(s) such as in a print cartridge to achieve at least a portion of its functionality. Examples of such printing devices may include, but are not limited to, printers, facsimile machines, photocopiers, and the like. Examples of other fluid ejection devices may include various devices such as Lab-On-A-Chip used in various medical and laboratory setting among others.

FIG. 2 shows an exemplary print cartridge 202 that may be used in an exemplary printing device such as printer 100. Print cartridge 202 is comprised of a print head 204 and a cartridge body 206 configured to couple with the print head. Cartridge body 206 may supply ink to print head 204 and may contain an internal ink supply and/or be connected to an external ink supply. Ink received by print head 204 may be ejected in the form of droplets from an outwardly facing surface 208.

While a single print head 204 is shown on print cartridge 202, other print cartridges may have multiple print heads on a single print cartridge. Some suitable print cartridges may be disposable, while others may have a useful lifespan equal to or exceeding that of the printing device. Other exemplary configurations will be recognized by those of skill in the art.

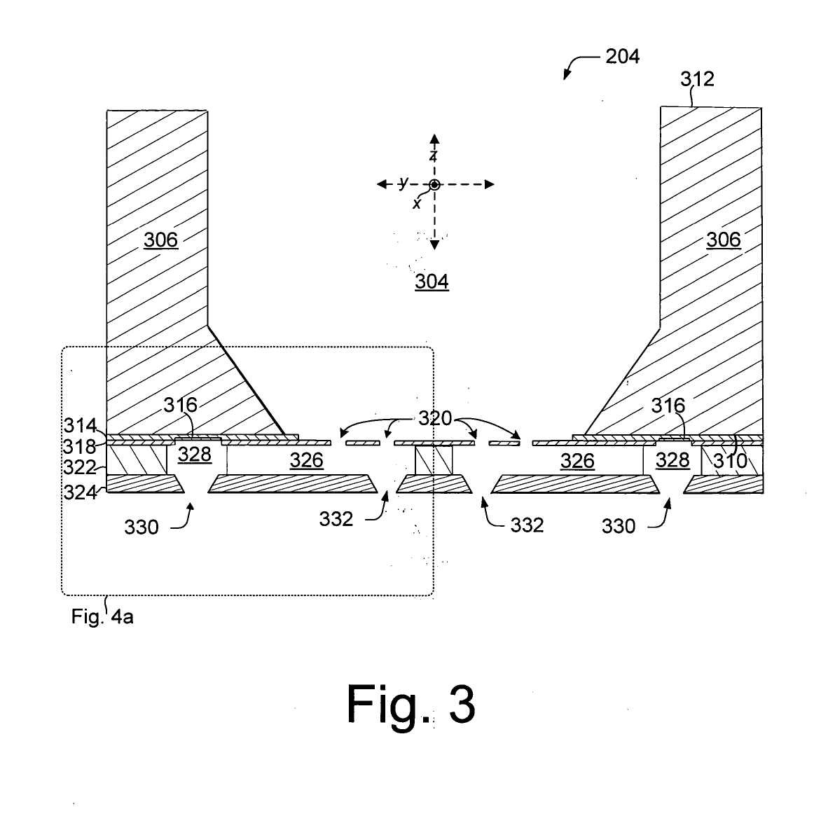

FIG. 3 shows a cross-sectional representation of print head 204 as shown in FIG. 2. This cross-sectional view is taken along the y-axis of print head 204. A slot or slots 304 passes through a substrate 306 from a first substrate surface 310 to a generally opposite second substrate surface 312. Slot 304 may have any suitable dimensions. For example, the slot may have any suitable length as measured parallel to the x-axis, with some embodiments having slots in the range of 20,000 microns. Similarly, any suitable slot width taken parallel to the y-axis may be utilized, with many embodiments utilizing slot widths in the 100-200 micron range. Both narrower and wider widths are also suitable.

In this particular embodiment, substrate 306 comprises silicon which either may be doped or undoped. Other substrate materials may include, but are not limited to, gallium arsenide, gallium phosphide, indium phosphide, glass, quartz, ceramic or other material.

Substrate thickness t may have any suitable dimensions that are appropriate for an intended application. In some embodiments substrate thicknesses t may range from less than 100 microns to more than 2000 microns. One exemplary embodiment may utilize a substrate that is approximately 675 microns thick, though if the current trend toward miniaturization continues, future embodiments may commonly utilize substrates having a thickness of 100-300 microns or less.

Though a single substrate is discussed herein, other suitable embodiments may comprise a substrate that has multiple components during assembly and/or in the finished product. For example, one such embodiment may employ a substrate having a first component and a second sacrificial component which is discarded at some point during processing.

One or more thin-film layers 314 may be positioned over first surface 310. Thin-film layers 314 may form various electrical components, such as heating element 316 and/or piezoelectric crystals, transistors and electrical traces which are not specifically shown. Individual heating elements 316 are electrically connected to individual electrical traces. Electrical energy may be selectively supplied to the heating elements to cause ink to be ejected from print head 204. Embodiments utilizing other electrical components such as piezoelectric crystals or other ejection means may be energized similarly to eject ink.

In some embodiments one or more of a filter 318 that has apertures 320 formed therein, a barrier layer 322 and an orifice layer 324 may be positioned adjacent thin-film layers 314. Ink may pass from slot 304 through apertures 320 to ink-feed passageways (“passageways”) 326. Ink may be supplied from an individual passageway 326 to a chamber 328.

Passageways 326 and chambers 328 may be defined at least in part by barrier layer 322. Ink may be ejected selectively from a chamber 328 via a respectively positioned nozzle 330 formed in orifice layer 324. Nozzles 330 comprise a first nozzle type. A second different nozzle type also is defined by orifice layer 324 in some embodiments. In this embodiment the second nozzle type comprises an air purge opening 332 configured to evacuate bubbles from the print head as will be discussed in more detail below.

In one embodiment filter 318 comprises a generally planer photo-imagable polymer filter layer positioned over the substrate's first surface 310. In this particular embodiment the photo-imagable filter layer is spun-on over the thin-film layers 314 prior to completion of slot 304. The photo-imagable filter layer is patterned and etched to form apertures 320. Further, in this embodiment, barrier layer 322 is positioned over filter 318 before etching. The skilled artisan will recognize other suitable configurations. For example, other filters may comprise different materials and/or may utilize other aperture shapes and/or sizes. In one such example a stainless steel filter may be utilized.

Individual heating elements 316 may be positioned within or proximate to an individual chamber 328. In some embodiments chamber(s) 328 may be defined, at least in part, by barrier layer 322 and orifice layer 324. Other configurations are also possible. In this embodiment passageway 326 and chamber 328 are patterned into barrier layer 322. As will be recognized by the skilled artisan, this is but one suitable configuration. Barrier layer 322 may comprise, among other materials, a patternable material such as a photo-imagable polymer substrate, however, other material may be utilized.

In one embodiment orifice layer 324 comprises a nickel substrate. In another embodiment orifice layer 324 is the same material as the barrier layer. The various layers may be formed, deposited, or may be attached upon the preceding layers. The configuration given here is but one possible configuration. For example, in an alternative embodiment, orifice layer 324 and barrier layer 322 comprise a single layer of material.

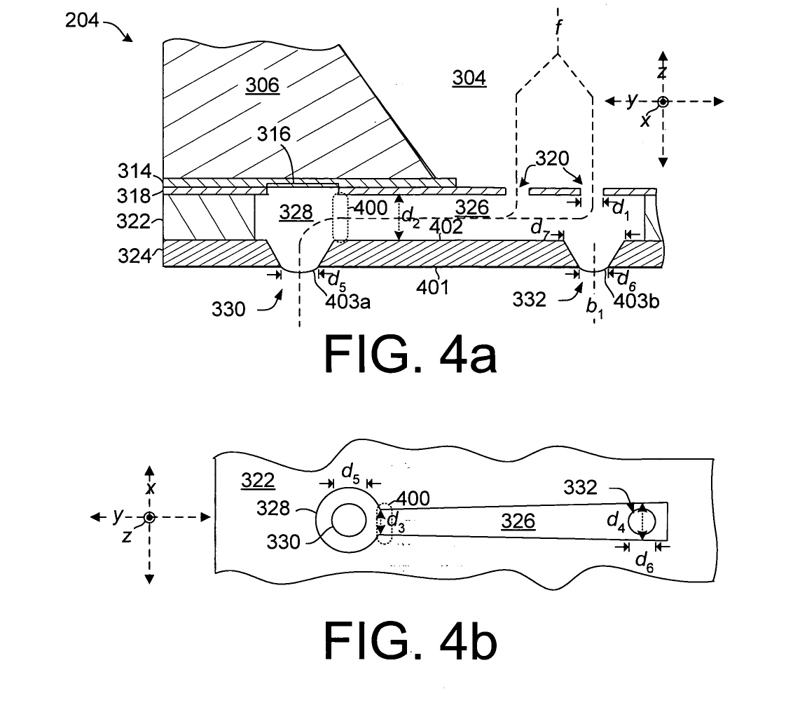

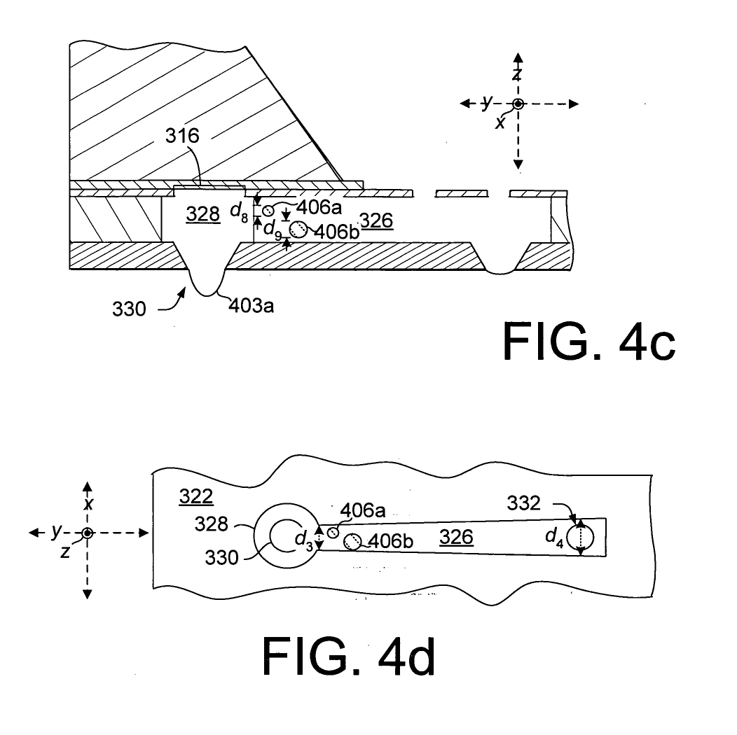

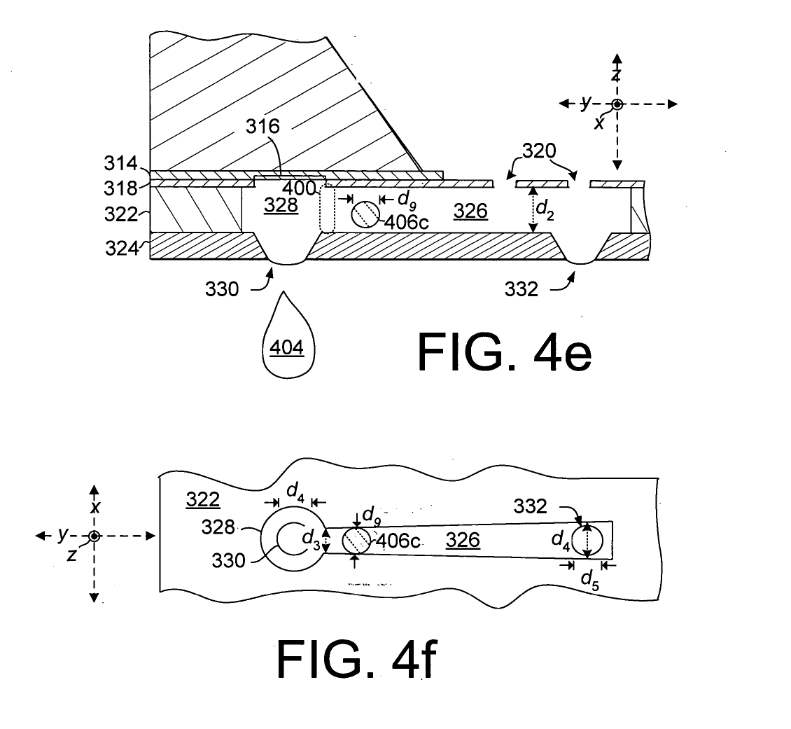

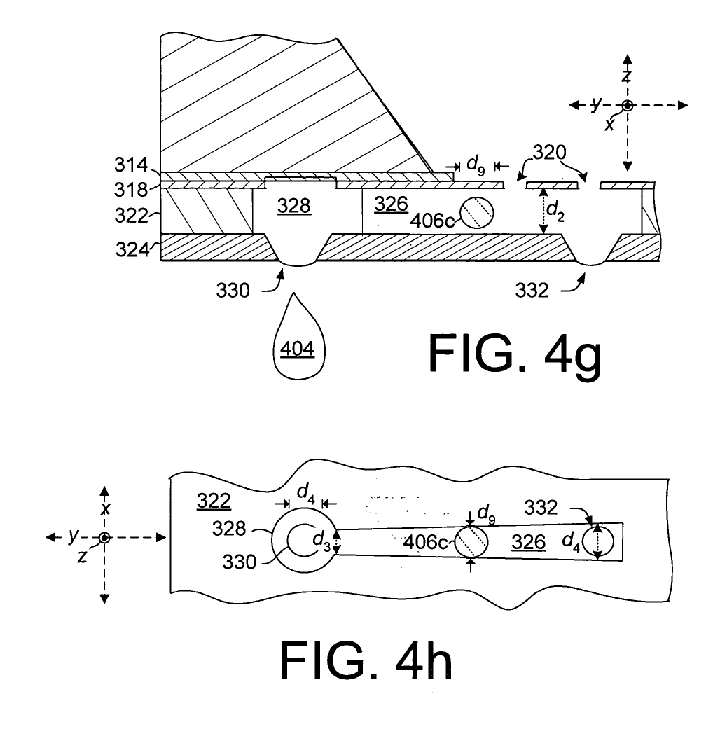

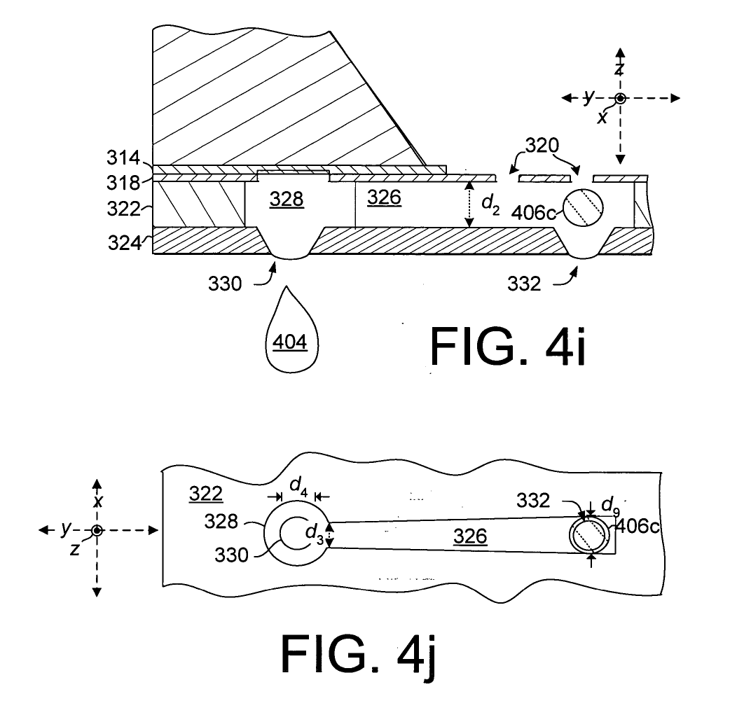

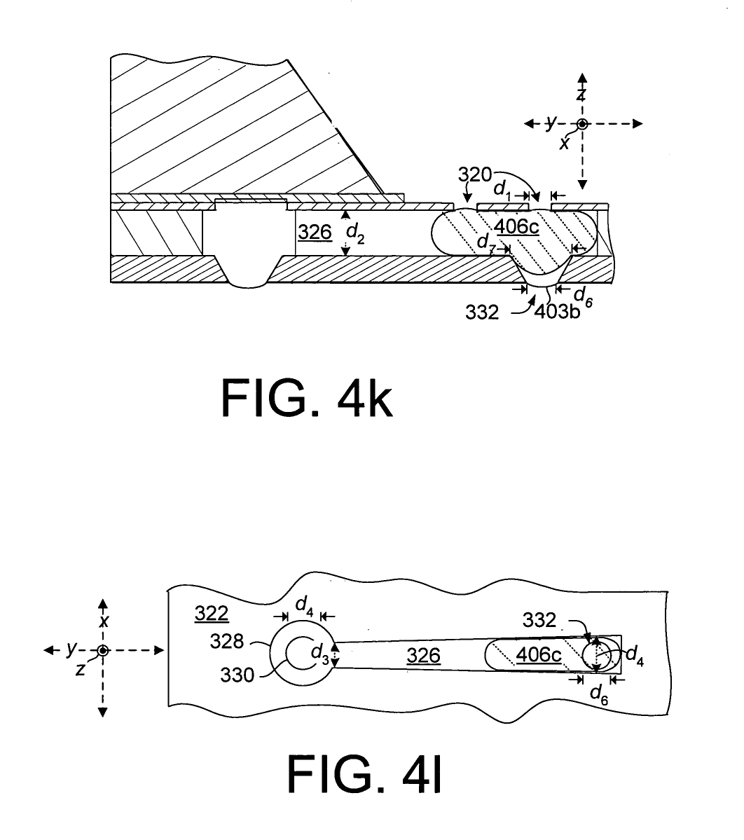

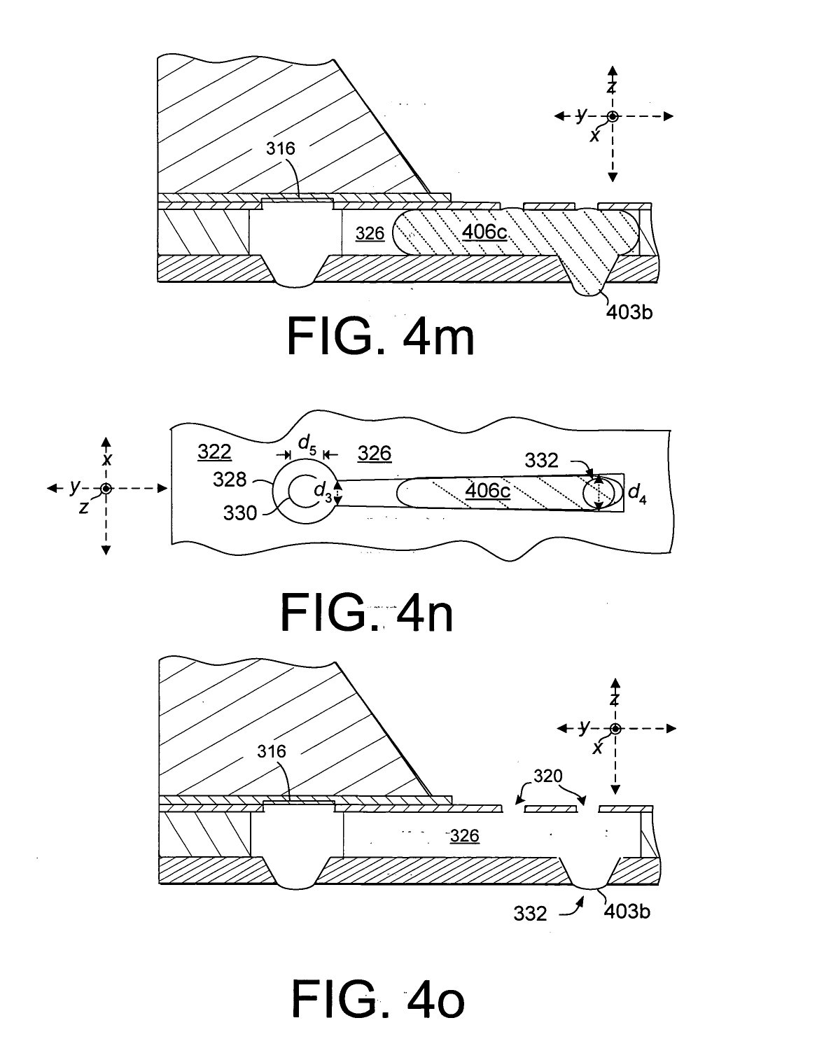

FIGS. 4a-4o illustrate a portion of print head 204 as indicated in FIG. 3. FIGS. 4a, 4c, 4e, 4g, 4i, 4k, 4m and 4o illustrate cut-away cross-sectional views taken transverse to slot 304 along the x-axis. FIGS. 4b, 4d, 4f, 4h, 4j, 4l and 4n illustrate top views of a portion of print head 204 taken along a xy-plane.

FIGS. 4a-4b illustrate a portion of a fluid path f extending from slot 304 and out through nozzle 330. Passageway 326 defines a portion of fluid path f and is fluidly coupled to adjoining structures including chamber 328 and slot 304 through apertures 320 and passageway-to-chamber opening 400.

Apertures 320 are configured to allow ink into passageway 326 from slot 304. In this embodiment two apertures 320 supply passageway 326. Other embodiments may utilize more or less apertures to supply a passageway. Alternatively or additionally, other supply configurations also may be utilized, examples of which will be discussed below.

In this embodiment individual apertures 320 are generally circular when viewed transverse to fluid path f. Apertures 320 have a diameter d₁, which in one embodiment is approximately about 8 microns measured orthogonally to fluid path f. Herein, openings such as apertures 320 will be described with a single dimension comprising a diameter where the opening is circular when viewed transverse fluid path f. Other configurations will be described with two dimensions such as a width and a height or a width and a length each taken orthogonal to a respective portion of fluid path f passing through the opening. The respective portion of the fluid path may be considered to comprise a bore axis of the opening.

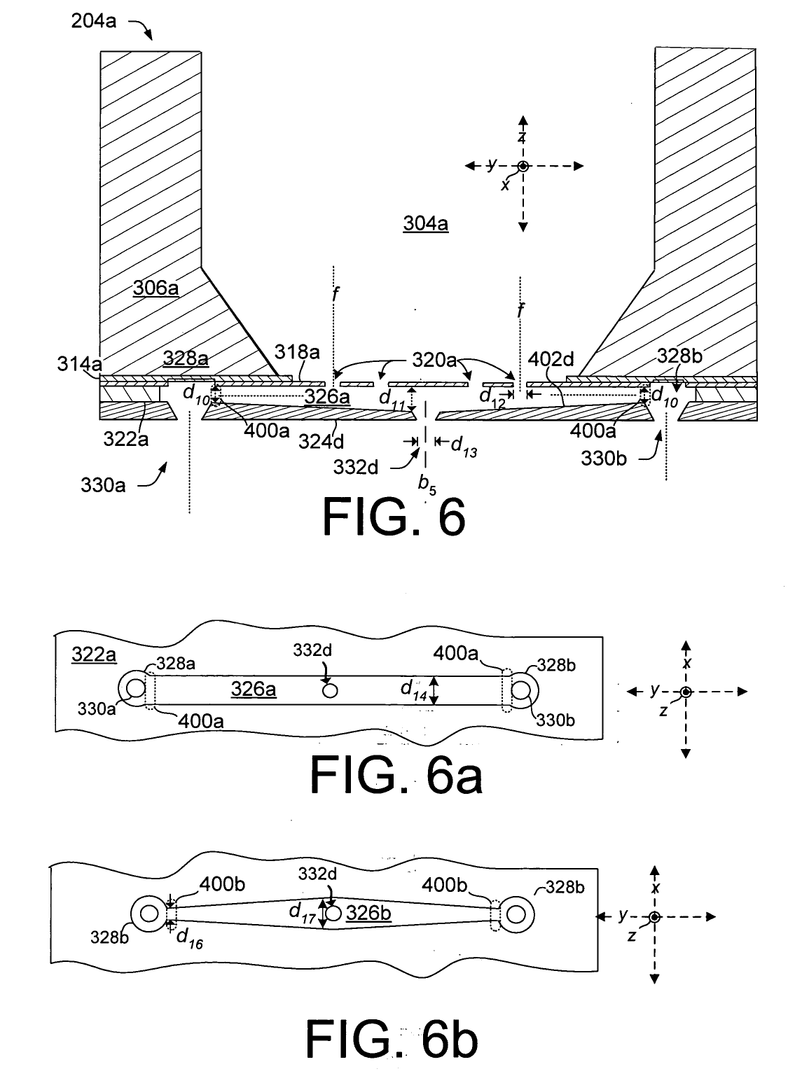

In the embodiment of FIGS. 4a and 4b passageway 326 and chamber 328 are defined by barrier layer 322. Nozzle 330 and air purge opening 332 are defined in orifice layer 324. In this particular embodiment passageway 326 may have a generally constant height d₂ of about 20 microns. Examples of other configurations are described below in relation to FIG. 6.

Passageway-to-chamber opening 400 has, in one embodiment, a first width d₃ of about 10 microns and a height d₂ of 20 microns. Passageway 326 tapers outward from the passageway-to-chamber opening 400 to a second width d₄ which in one embodiment of about 20 microns proximate air purge opening 332.

Nozzle 330 has a diameter d₅, which in one embodiment is about 15 microns measured transverse the fluid path f. Air purge opening 332 extends along a bore axis b₁ and has a first diameter d₆, which in one embodiment is about 13 microns measured transverse the bore axis and proximate an outer surface 401 of orifice layer 324. In this embodiment air purge opening 332 also has a second larger diameter d₇, which in one embodiment is about 20 microns measured proximate inner surface 402 of orifice layer 324.

While in the embodiment of FIGS. 4a and 4b apertures 320, nozzle 330 and air purge opening 332 are generally depicted as being circular, other suitable embodiments may utilize other geometric shapes such as rectangular and elliptical shapes among others.

During operation, ink, not specifically shown, may flow along fluid path f until it is ejected through nozzle 330. For example ink flows from slot 304 into passageway 326 through apertures 320. Ink then is supplied from passageway 326 to chamber 328 through the passageway-to-chamber openings 400. The ink forms a meniscus 403a, 403b over nozzle 330 and air purge opening 332, respectively, commensurate with a typical slightly negative gage pressure within slot 304.

As depicted in FIGS. 4c-4f, ink may be ejected selectively from chamber 328 by energizing a respective heating element 316 sufficiently to heat and to vaporize some of the ink adjacent to the heating element and contained in the chamber. Vaporization of ink contained in chamber 328 may increase pressure within the chamber. When the pressure within the chamber becomes sufficient to overcome the surface tension and pressure at the air fluid interface a droplet of ink 404 is ejected from the chamber's nozzle 330 as illustrated in FIG. 4e. Following ejection ink enters chamber 328 and meniscus 403a is reformed.

Energizing ink to cause ejection from the chamber also may have other consequences. For example, as the temperature of the ink increases, the solubility of gases in the ink decreases. As a result, gases which are in solution in the ink may ‘out-gas’ and form bubbles 406a, 406b in chamber 328 and associated passageway 326. Out-gassing is but one example of how bubbles may occur in the print head. Other sources may be the vaporization process in the chamber, “gulping” air into nozzle during a refill process after an ink drop is ejected, and bubbles carried along with the ink from the ink supply, among other sources.

As shown in FIGS. 4c-4d, bubbles 406a, 406b have diameters d₈, d₉ which in one embodiment are 5 microns and 8 microns respectively. The smallest dimensional constraint proximate the bubbles is passageway width d₃, which in one embodiment is 10 microns. Bubbles are able to assume a low energy configuration generally approximating a sphere, based upon the cross-sectional area of passageway 326.

As depicted in FIGS. 4e-4f, the previously illustrated bubbles (406a, 406b) have grown and/or have coalesced along with other bubbles into a single larger bubble 406c. Bubble 406c has a diameter d₉ of approximately 10 microns which is similar to the passageway's width d₃ proximate the bubble. If the bubble continues to grow, width d₃ begins to constrain the bubble from expanding in the x and z dimension and causes the bubble to instead expand in they dimension and therefore deform from a generally spherical shape.

Deforming bubble 406c causes a driving force that may move the bubble along passageway 326 away from passageway-to-chamber opening 400 and toward the air purge opening end of passageway 326 which is less constraining in the x-dimension and allows the bubble to achieve a more spherical configuration. The result of the driving force may be seen in FIGS. 4g-4h where bubble 406c has moved along passageway 326 toward the wider air purge opening end of the passageway. As illustrated in FIGS. 4g-4h, bubble 406c has a diameter d₉ of about 15 microns which is similar to the passageway's width proximate bubble 406c.

As bubble 406c continues to expand, x-dimensional constraints continue to provide a driving force for the bubble. As may be seen in FIGS. 4i-4j in this instance the driving force is sufficient to continue moving bubble 406c along the passageway's taper toward air purge opening 332 where the bubble now has a diameter d₉ of about 20 microns and is located at the least constraining portion of passageway 326. In this location bubble 406c has the largest spherical shape it may, given the x, z constraints of passageway 326. Further bubble growth now is governed by the energy balance between the radius of curvature experienced in the three (x, y, and z) dimensions. In this embodiment the most notable bubble growth is towards the chamber (in y-axis) towards the air purge opening (z-axis), with the bubble seeking equilibrium in these two primary directions of growth.

As may be seen in FIGS. 4k-4l, bubble 406c has continued to expand and is forced by the dimensional constraints of passageway 326 to expand in they and z-dimensions and as such to assume a non-spherical shape.

As seen in FIGS. 4m-4o bubble 406c may continue to grow along the y-dimension back toward the chamber end of the passageway 326 until it reaches a point where the passageway becomes more constrictive than another opening available to the bubble. In this embodiment bubble 406c grows toward the chamber 328 until continued expansion down the passageway 326 would require the bubble to assume a higher energy state than expanding into air purge opening 332 and overcoming the surface tension and pressure at the air fluid interface. In this particular embodiment such a point may occur where the passageway's width is less than or equal to the air purge opening's diameter d₆. In some embodiments this may occur where the passageway's width is somewhat less than the width d₆ of the air purge opening, thus allowing the energy state to become high enough to distend the bubble into the air purge opening and to overcome the meniscus. As the volume of bubble 406c continues to increase, the bubble achieves a sufficiently high energy state to overcome the surface tension of meniscus 403b. When the energy state of the bubble becomes great enough to overcome the surface tension of the meniscus, the meniscus will ‘break’ allowing the gas comprising the bubble to evacuate or to be expelled from the print head through the air purge opening 332.

FIG. 4o shows print head 204 after the bubble has evacuated from air purge opening 332 and meniscus 403b has reformed. Expulsion of the bubble may be facilitated by the capillary pressure of ink proximate the bubble. In some embodiments firing heating element 316 may be energized one or more times to create a pressure surge or surges through the ink to facilitate purging the bubble. Meniscus 403b reforms once the gas comprising the bubble is purged from the print head. If additional bubbles form, the process may be repeated.

In this embodiments movement and/or expansion of a bubble in a desired direction within a space such as a passageway may be achieved by providing an environment within the space that tapers or otherwise encourages a bubble to move and/or to expand from a more constraining region of the space into a less constraining region. In this particular embodiment the more constraining region is proximate the chamber and the less constraining region is proximate the air purge opening. This embodiment also selects relative dimensions of openings leading into and out of the passageway to foster bubbles to pass through a desired opening and/or not through other openings. Air purge opening 332 has relatively larger dimensions when compared to apertures 320 and the passageway-to-chamber opening 400 so that a bubble experiences a larger radius of curvature passing through the air purge opening than either the apertures 320 or the passageway-to-chamber opening 400. As such bubbles may be managed within the print head by purging through the air purge opening.

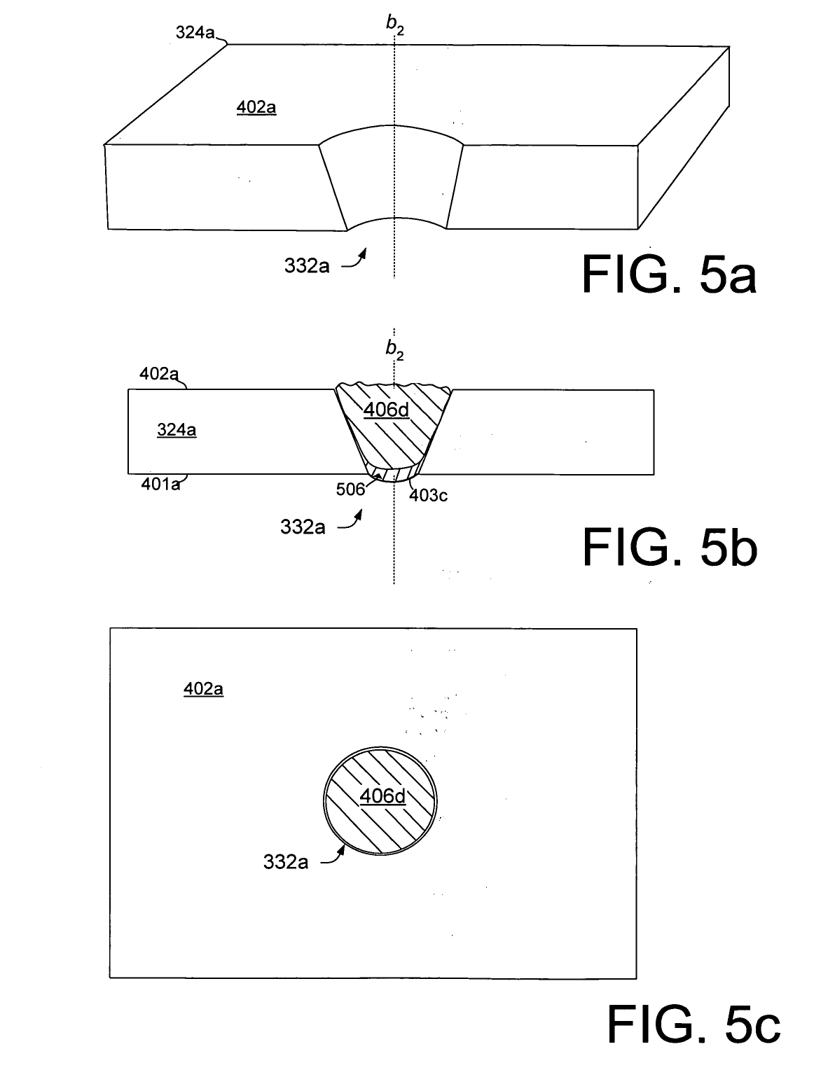

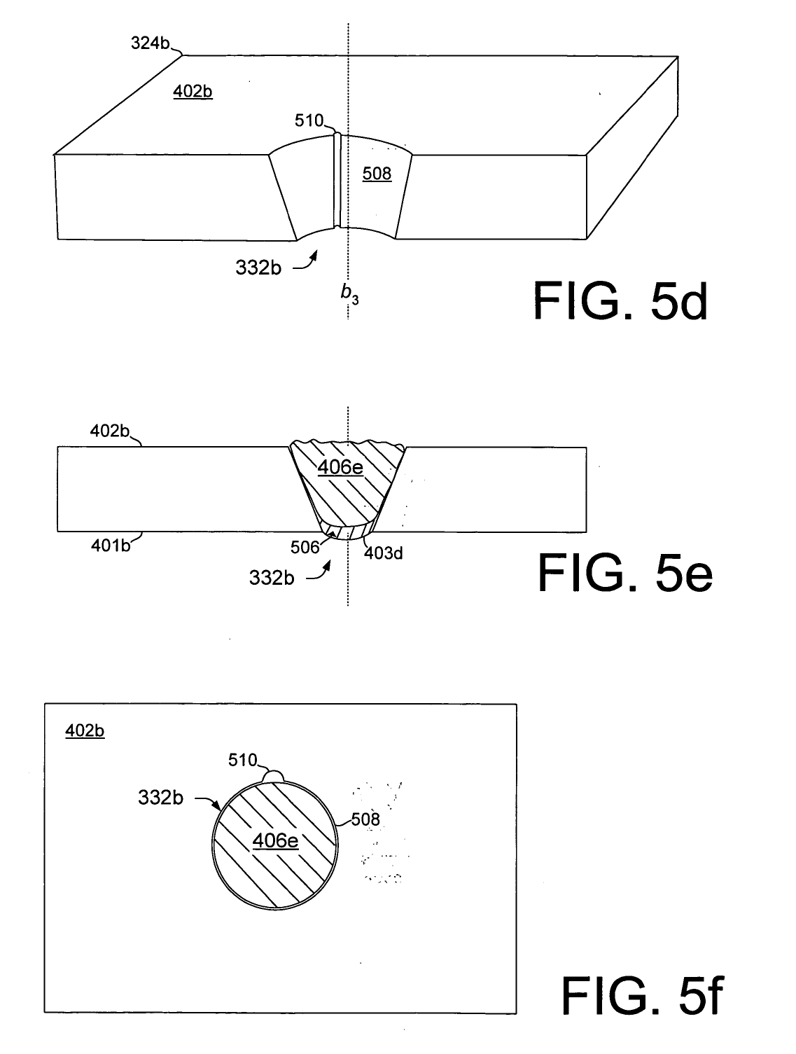

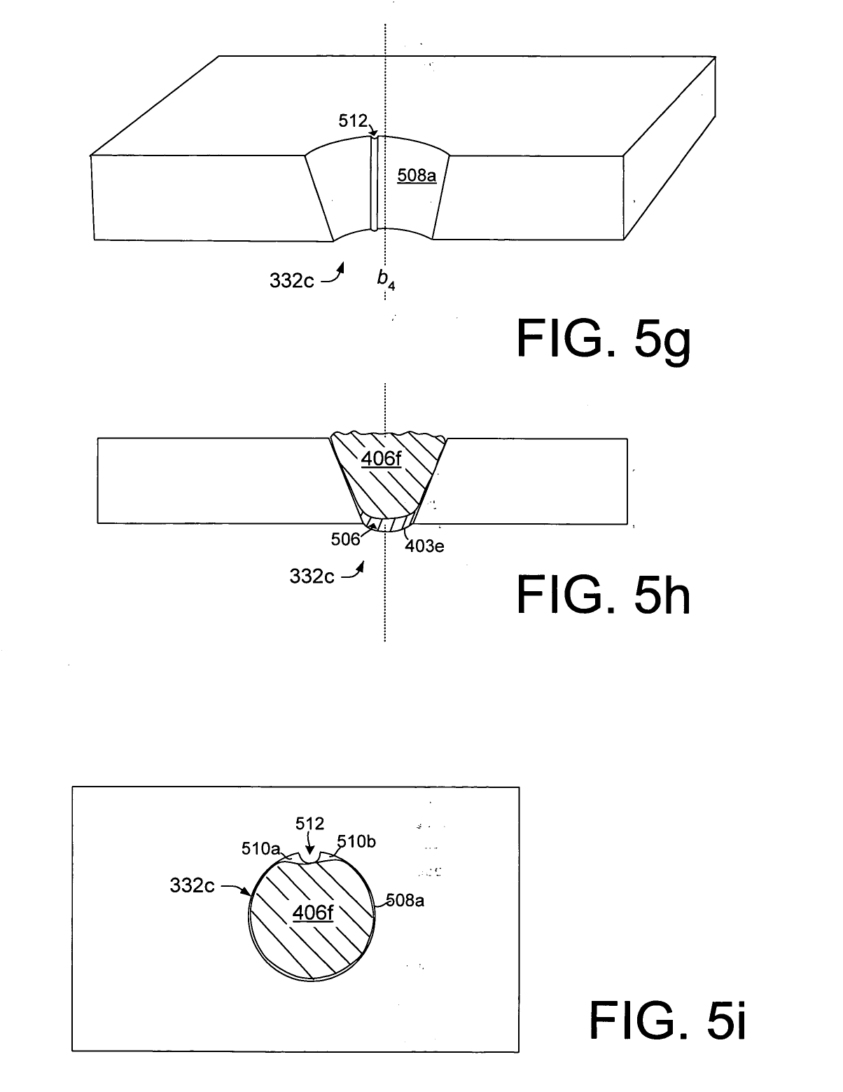

FIGS. 5a-5i illustrate several exemplary air purge opening configurations.

FIGS. 5a-5c show one embodiment of a air purge opening 332a formed in orifice layer 324a. FIG. 5a illustrates a cut-away perspective view of a portion of another exemplary fluid ejection device in accordance with one embodiment. FIG. 5b illustrates a cross-sectional view of a portion of the exemplary fluid ejection device illustrated in FIG. 5a in accordance with one embodiment. FIG. 5c illustrates a top view of a portion of the exemplary fluid ejection device illustrated in FIG. 5a in accordance with one embodiment.

Air purge opening 332a extends through orifice layer 324a between a first surface 401a and a second generally opposing surface 402a and along bore axis b₂ which is generally orthogonal to first surface 401a. Orifice layer 324a is configured for second surface 402a to be positioned toward a print head's barrier layer as described above in relation to FIG. 3.

In this embodiment air purge opening 332a is generally frusto-conical shaped. Other exemplary shapes include hemispherical, bowl-shaped and cylindrical among others.

As may be appreciated from FIGS. 5b-5c, ink 506 may get trapped within air purge opening 332a when a portion of bubble 406d, shown FIGS. 5b-5c, expands into the air purge opening. Ink 506 may be trapped proximate second surface 402a when bubble 406d expands into the air purge opening 332a and generally conforms to the circular shape of the air purge opening as may be seen in FIG. 5c. Ink 506 trapped in the air purge opening 332a may increase in some instances the pressure sufficient to overcome the surface tension and pressure at the air fluid interface. Alternatively or additionally, the trapped ink may be expelled from a print head with the bubble when the meniscus is overcome.

FIGS. 5d-5f show an alternative embodiment of air purge opening configuration that tends to allow ink to evacuate from air purge opening 332b back into the print head in the presence of bubble 406e shown in FIGS. 5e-5f. FIGS. 5d-5f illustrate views similar to those of FIGS. 5a-5c respectively. In this embodiment air purge opening 332b has a central region 508 joined with at least one capillary region 510. In this embodiment central region 508 is generally frusto-conical shaped and extends through the orifice layer 324b along bore axis b₃. Capillary region 510 extends at least part way through orifice layer 324b. In this embodiment, capillary region 510 extends entirely between first surface 401b and second surface 402b. In this embodiment capillary region 510 generally approximates a portion of a cylinder. Other shapes may provide a similar functionality.

As may be appreciated from FIG. 5f, bubble 406e tends to expand to fill central region 508, but generally does not fill capillary region 510 which provides a path for ink 506 to evacuate back past first surface 401b into the overlying portions of a print head. Providing an evacuation path for the ink may allow bubble 406e to more easily to overcome the surface tension and pressure at the air fluid interface and prevent expulsion of ink from air purge opening 332.

FIGS. 5g-5i show an additional embodiment of an air purge opening configuration that tends to allow ink to evacuate from air purge opening 332c back into the print head in the presence of a bubble 406f. FIGS. 5g-5i illustrate views similar to those of FIGS. 5d-5f respectively. In this embodiment air purge opening 332c has a central region 508a. A rib of orifice material indicated generally at 512 extends into central region 508a. In this embodiment rib 512 generally approximates a portion of a cylinder. Other shapes may provide a similar functionality.

As may be appreciated from FIG. 5i, rib 512 causes bubble 406f to assume a configuration which leaves two capillary regions 510a, 510b for ink to evacuate along.

The skilled artisan should recognize other suitable air purge opening configurations may be utilized.

FIGS. 6-6a illustrate another exemplary print head configuration. FIG. 6 illustrates a cross-sectional view of print head 204a similar to that illustrated in FIG. 3, while FIG. 6a illustrates a view similar to the view illustrated in FIG. 4b. In this embodiment a pair of chambers 328a, 328b formed in barrier layer 322a and positioned on opposing sides of slot 304a is supplied via a common passageway 326a. Ink is supplied along fluid path f from slot 304a into passageway 326a through apertures 320a formed in filter 318a. Nozzles 330a, 330b are positioned below chambers 328a, 328b respectively.

An air purge opening 332d is positioned along passageway 326a between chambers 328a, 328b. In this embodiment, the passageway's height d₁₀ proximate chamber 328a is less than height d₁₁ proximate air purge opening 332d. The passageway's height in the z-direction between filter 318a and orifice layer 324d is generally tapered from the value at d₁₀ to the value at d₁₁. In this particular embodiment the orifice layer's inner surface 402d is patterned utilizing a gray-scale etch to achieve the tapered configuration. Other embodiments may achieve a tapered passageway height in the z-direction by creating the taper in the filter 318a, thin-films 314a and/or substrate 306a among others.

The tapered configuration of passageway 326a tends to cause bubbles located in the passageway to move and/or to expand toward air purge opening 332d. The relative dimensions of the air purge opening encourage bubbles to exit passageway 326a through the air purge opening rather than through the apertures 320a or into the chamber 328a.

In this embodiment, apertures 320a extend through filter 318a along fluid path f and have a diameter d₁₂ of 10 microns which is less than a diameter d₁₃ of 15 microns taken along the air purge opening's bore axis b₅. The air purge opening's diameter d₁₃ is greater than at least one of the dimensions leading from passageway-to-chamber opening 400a. In this particular embodiment the passageway-to-chamber opening dimensions comprise height d₁₀ of 10 microns in the z-direction and width d₁₄ of 20 microns in the x-direction. Passageway-to-chamber opening height dimension d₁₀ of 10 microns is more constraining than the 15 micron diameter d₁₃ of air purge opening 332a. Likewise, 10 micron diameter d₁₂ of aperture 320a is more constraining than the air purge opening's 15 microns. As a result, a bubble expanding in passageway 326a will tend to pass through air purge opening 332d rather than through apertures 320a or into passageway-to-chamber opening 400a.

FIG. 6b illustrates an alternative passageway configuration which may aid in moving bubbles toward air purge opening 332d. This particular embodiment maintains the tapered passageway height described in relation to FIG. 6. This embodiment further adds a tapered passageway width to further encourage a bubble in passageway 326b to move and/or to expand toward air purge opening 332d and away from chamber 328b.

Passageway 326b has a width d₁₆ at its passageway-to-chamber opening 400b that is narrower than its width d₁₇ proximate to and at air purge opening 332d. The passageway tapers between these two values. Such a configuration may promote bubble movement toward the air purge opening 332d. As the bubble continues to grow with out-gassing or coalescing it will grow toward the largest dimension in the system. So the bubble grows within passageway 326b along the y-axis toward air purge opening 332d until it distends into air purge opening 332d and overcomes its meniscus. At this point the bubble may purge from the system through the air purge opening.

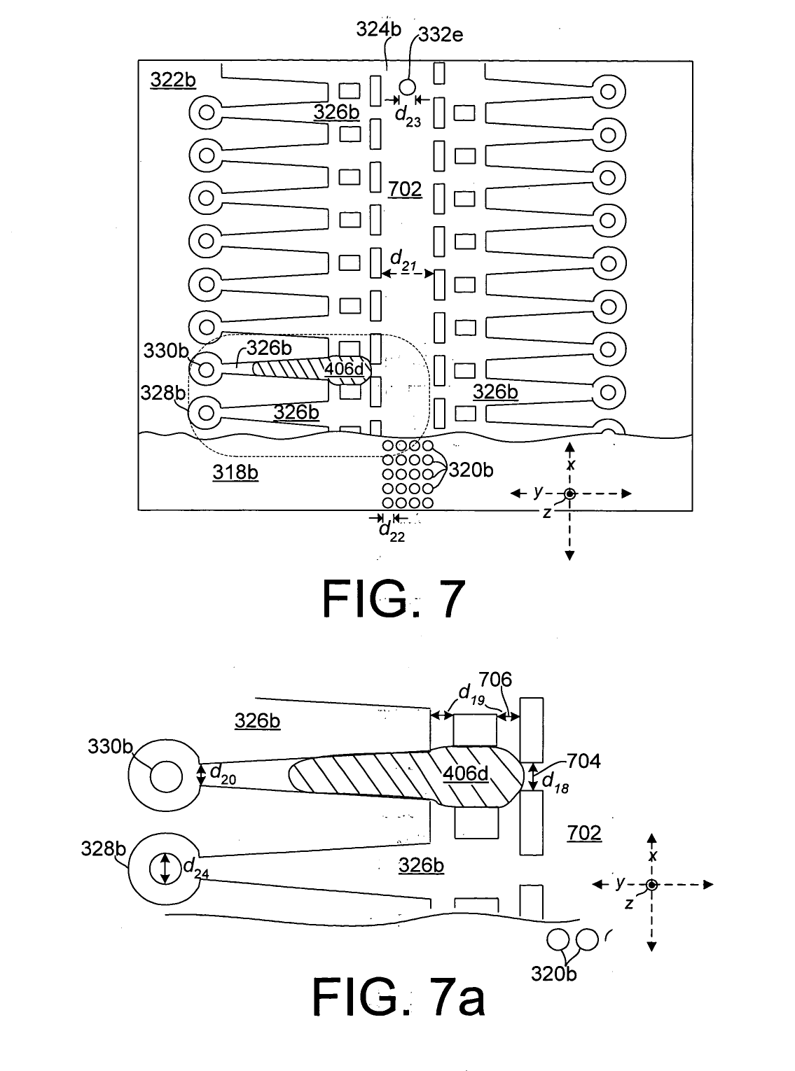

FIGS. 7-7a illustrate still another exemplary print head configuration. FIG. 7 illustrates a top view of filter 318b, barrier layer 322b and orifice layer 324b without the overlying substrate. For the purposes of illustration, filter 318b is shown partially cut-away. FIG. 7a shows a somewhat enlarged view of a portion of the components as indicated in FIG. 7.

This embodiment employs a manifold region 702 formed in barrier layer 322b. Manifold region 702 may receive ink through apertures 320b. Ink may enter an individual passageway 326b from one or more openings. Examples of openings, in various embodiments, may include apertures 320b, a manifold-to-passageway opening 704 and a passageway-to-passageway opening 706. Manifold-to-passageway opening 704 has a dimension d₁₈ that is larger than a dimension d₁₉ of passageway-to-passageway opening 706. In this embodiment the manifold-to-passageway dimension d₁₈ is about 12 microns while the passageway-to-passageway dimension d₁₉ is about 9 microns. Passageway-to-chamber dimension d₂₀ comprises 10 microns.

A bubble that is produced in, or otherwise occurs in an individual passageway 326b may grow, such as with continued outgassing, and will favor exiting through an opening into or out of the passageway having the least constrictive minimum dimension. This embodiment maintains a generally uniform distance of 20 microns in the z-direction as defined between orifice layer 324b and filter 318b. As such, the least constrictive opening comprises a manifold-to-passageway opening 704. Bubble 406c constrained in passageway 326b will tend to move through manifold-to-passageway opening 704 when a sufficient energy state is reached. Bubble 406c will not tend to migrate between adjacent passageways given that the smaller passageway-to-passageway openings 706 require a higher energy configuration to pass through than the manifold-to-passageway opening 704.

In this embodiment manifold region 702 has a width d₂₁ of about 50 microns taken along the short or y-axis, and a length in the x-direction similar to a length of an overlying slot. Bubbles in manifold region 702 tend to expand along the manifold region rather than pass through the more constricted dimensions of the manifold-to-passageway openings 704 or through apertures 320b which have a diameter d₂₂ of 9 microns. Air purge opening 332e having a diameter d₂₃ of 15 microns may provide the largest dimensional opening available to the bubbles as the manifold is filled in the x- and y-directions by the bubble. So bubbles in the manifold region 702 may expand within the manifold region until the dimensional constraints cause them to purge from air purge opening 332e.

In an alternative embodiment bubbles may be managed without an air purge opening. Instead, the relative dimensions of the openings into and out of a passageway may be selected to purge the bubbles out a respective nozzle. By making the passageway-to-chamber dimension d₂₀ and the nozzle diameter d₂₄ larger than the other passageway openings such as the manifold-to-passageway opening 704 and the passageway-to-passageway openings 706 a bubble when constricted in the passageway may migrate out through the nozzle without migrating into adjacent passageways and potentially occluding ink flow therein.

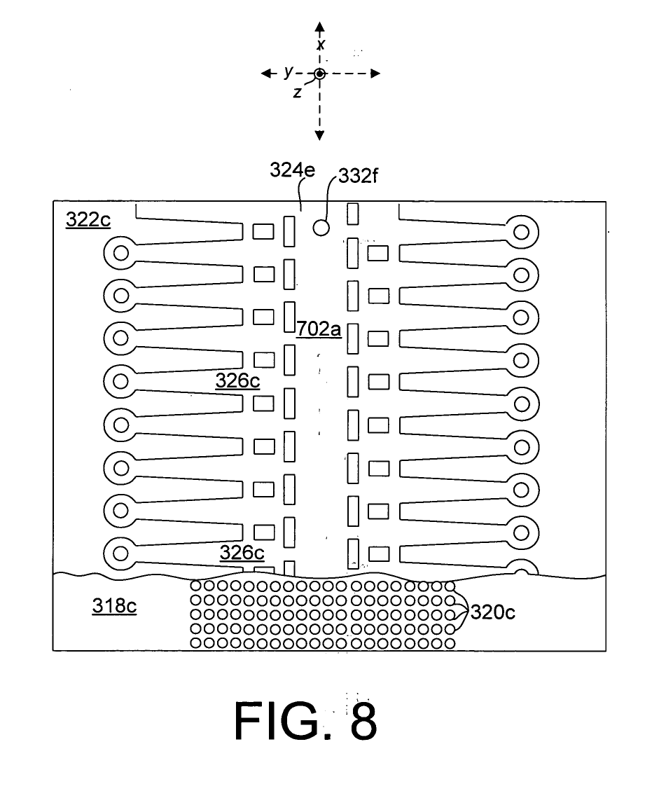

FIG. 8 illustrates an embodiment similar to that shown in FIG. 7. In this view orifice layer 324e underlies barrier layer 322c which underlies filter 318c. In this embodiment apertures 320c are positioned over passageways 326c as well as over the manifold region 762a. The dimensions are identical to those recited in relation to FIG. 7 so bubbles tend to migrate from the passageways 326c into the manifold region rather than into adjacent passageways 326c or through apertures 320c. Once in the manifold region 702a, bubbles migrate out of air purge opening 332f rather than back into the passageways.

In this embodiment individual passageways 326c may receive ink through apertures 320c positioned over the passageway and/or from adjacent passageways even when a bubble is occupying part or all of manifold region 702a. This configuration may contribute to maintaining adequate ink flow to the chambers in the presence of a bubble in the manifold region.

The incidence of bubbles in a print head may vary depending on the operating status of the print cartridge. When the print cartridge is used periodically, ink may solidify or may crust proximate an air purge opening. Some embodiments may position a firing heating element or other energizing device proximate an air purge opening. The heating element may be energized from time to time, such as when the print head is positioned over a service station. Energizing the heating element may eject ink which may expel any crusted or dried ink proximate the air purge opening which may otherwise begin to obstruct the air purge opening.

While specific examples of suitable dimensions are provided above for the purposes of explanation, the skilled artisan should recognize that many other suitable dimensions would be equally suitable.

The embodiments described above provide various structures and methods for managing gas bubbles as they occur in a fluid ejection device, such as a print head. Other exemplary embodiments may manage bubbles in other ways and/or in other locations. For example one suitable embodiment may position a bubble managing structure at a convenient location along the fluid-feed path. Another example may position air purge openings at either end of the nozzle columns shown in FIGS. 7 & 8. The structure may be designed to proactively reduce an amount of gas contained in ink subsequently supplied to the print head by producing a bubble through nucleation and maintaining continual outgassing through localized heating of the ink. The structure may be configured to define a space through which the fluid-feed path passes.

In one such embodiment a structure may define a space through which ink flows. The ink may be heated as it passes through the structure to cause outgassing and resultant bubbles. The bubbles may be managed by purposefully selecting the relative size and shape of the openings coupled to the space in combination with the shape of the space. For example ink may travel along the fluid-feed path and may enter the space through a first opening and may exit through a second opening. A third opening having a minimum dimension larger than a minimum dimension of either of the first and second openings may allow bubbles to exit the space and further to be effectively separated from the ink. This process may be further augmented by tapering the shape of the space so that a least confining region of the space is proximate the third opening. This is but one additional exemplary embodiment for managing bubbles. The skilled artisan should recognize other suitable configurations.

The described embodiments may provide methods and systems for managing bubbles in a print head or other fluid ejection device. The bubbles may be managed by controlling the relative dimensions of opening leading into or out of a space such as an ink-feed passageway. Some embodiments utilize an air purge opening as one of the openings and select relative dimensions which promote migration of a bubble through the air purge opening rather than other openings.

Although the inventive concepts have been described in language specific to structural features and methodological steps, it is to be understood that the appended claims are not necessarily limited to the specific features or steps described. Rather, the specific features and steps are disclosed as forms of implementation.

1. A fluid ejection device comprising:
a chamber configured to eject fluid droplets through a nozzle;
a fluid-feed passageway configured to supply fluid to the chamber through a first opening and configured to receive fluid through at least a second different opening; and,
a third opening coupled with the fluid-feed passageway and configured primarily to evacuate bubbles from the fluid ejection device.

2. The fluid ejection device of claim 1, wherein the third opening extends to an outer surface of the fluid ejecting device from which the fluid droplets are ejected.

3. The fluid ejection device of claim 1, wherein the third opening comprises an opening formed in an orifice layer.

4. The fluid ejection device of claim 1, wherein first opening extends along a first bore axis and the at least a second different opening extends along a second bore axis and the third opening extends along a third bore axis and wherein a minimum dimension of the third opening taken orthogonally to the third bore axis is greater than a minimum dimension of the first opening taken orthogonally to the first bore axis and a minimum dimension of the at least a second opening taken orthogonally to the second bore axis.

5. The fluid ejection device of claim 1, further comprising a nozzle and wherein the nozzle is positioned adjacent the chamber and the third opening is positioned adjacent the fluid-feed passageway.

6. The fluid ejection device of claim 1, wherein the third opening comprises a central region and a capillary region.

7. The fluid ejection device of claim 1, wherein the third opening comprises a central region and a rib.

8. The fluid ejection device of claim 1, wherein the air purge opening is positioned over the fluid-feed passageway.

9. The fluid ejection device of claim 1 embodied as a print head.

10. A fluid ejection device comprising:
a chamber configured to eject fluid through a nozzle in a surface of the fluid ejecting device;
a fluid passageway configured to receive fluid through at least a first opening and to deliver fluid through at least a second different opening to the chamber; and,
a means for removing bubbles from the passageway.

11. The fluid ejection device of claim 10, wherein the means for removing is configured to remove the bubbles through the surface.

12. A fluid ejection device comprising:
a pair of chambers configured to eject fluid;
a fluid-feed passageway extending generally between the pair of chambers and configured to supply fluid to the pair of chambers through a pair of openings; and,
at least one other opening interposed along the passageway to remove air from the fluid ejection device.

13. The fluid ejection device of claim 122, wherein the fluid-feed passageway is generally tapered from the openings toward the at least one other opening.

14. The fluid ejection device of claim 12, wherein the fluid-feed passageway has a first dimension measured orthogonally to a length between the openings that is less than a second dimension measured orthogonally to the length and proximate the at least one other opening.

15. The fluid ejection device of claim 14, wherein the fluid-feed passageway has a third dimension measured orthogonally to the length s and orthogonally to the first dimension that is less than a fourth dimension measured orthogonally to the length and orthogonally to the second dimension and proximate the at least one other opening.

16. The fluid ejection device of claim 12, wherein the pair of chambers are configured to eject fluid through first type nozzles formed in an orifice layer, and wherein the at least one other opening comprises a second type nozzle formed in the orifice layer.

17. The fluid ejection device of claim 14, wherein the one other opening comprises a central region and a capillary region.

18. The fluid ejection device of claim 14, wherein the one other opening comprises a central region and a rib formed thereon.

19. A fluid ejection device comprising:
an orifice layer defining at least a first nozzle being configured to eject liquid from the fluid ejection device; and,
the orifice layer further defining at least a second different nozzle being primarily configured to evacuate bubbles from the fluid ejection device.

20. The fluid ejection device of claim 19, wherein the first nozzle is generally frusto-conically shaped and extends through the orifice layer along a first bore axis and the second different nozzle comprises a generally frusto-conically shaped region joined with a capillary region, wherein the frusto-conically shaped region extends through the orifice layer along a second bore axis and wherein the capillary region extends at least part way through the orifice layer.

21. The fluid ejection device of claim 19, wherein the first nozzle is generally frusto-conically shaped and extends through the orifice layer along a first bore axis and the second different nozzle comprises a generally frusto-conically shaped region having a rib formed thereon, wherein the frusto-conically shaped region extends through the orifice layer along a second bore axis and wherein the rib extends at least part way through the orifice layer.

22. The fluid ejection device of claim 19 embodied as a print head.

23. The fluid ejection device of claim 19, wherein first nozzle extends along a first bore axis and the at least second nozzle extends along a second bore axis, wherein a minimum dimension of the at least second nozzle taken orthogonally to the second bore axis is less than a minimum dimension of the first nozzle taken orthogonally to the first bore axis.

24. A fluid ejection device comprising:
at least one chamber for ejecting fluid received along a fluid-feed path;
the fluid-feed path extending through a first opening into a fluid-feed passageway and into the chamber through a second opening, wherein the first opening has a minimum dimension measured orthogonally to the fluid-feed path that is less than a minimum dimension of the second opening; and,
an air purge opening extending along a bore axis and fluidly coupled to the fluid-feed passageway and wherein the air purge opening has a minimum dimension measured orthogonally to the bore axis of the air purge opening that is greater than the minimum dimension of the second opening.

25. The fluid ejection device of claim 24, wherein the fluid-feed passageway tapers from a relatively wide region located proximate the air purge opening to a relatively narrow region located distal the air purge opening and proximal the chamber.

26. The fluid ejection device of claim 24, wherein the fluid-feed passageway tapers from a relatively wide region located proximate the air purge opening to a first relatively narrow region located distal the air purge opening and proximal the first opening and tapers from the relatively wide region to a second relatively narrow region proximate the second opening.

27. The fluid ejection device of claim 24, wherein the air purge opening comprises a central region and a capillary region.

28. The fluid ejection device of claim 24, wherein the air purge opening comprises a central region and a rib formed on the central region.

29. A fluid ejection device comprising:
a substrate having one or more layers positioned thereon; and,
a fluid-feed path extending through a space which is defined, at least in part, by the one or more layers, the space being tapered from a more constrained region to a less constrained region to move a bubble contained in the space toward the less constrained region.

30. The fluid ejection device of claim 29, further comprising a bubble evacuation means positioned proximate the less constrained region.

31. The fluid ejection device of claim 29, wherein the fluid-feed path enters the space through a first opening and exits the space through a second opening and wherein the second opening has a minimum dimension measured orthogonally to the fluid-feed path that is greater than a minimum dimension of the first opening measured orthogonally to the fluid-feed path.

32. The fluid ejection device of claim 31, further comprising a third opening extending from the space along a bore axis and configured to evacuate bubbles from the space, wherein a minimum dimension of the third opening measured orthogonally to the bore axis is greater than the minimum dimension of the second opening.

33. The fluid ejection device of claim 32, wherein the third opening comprises a central region and a capillary region.

34. The fluid ejection device of claim 32, wherein the third opening comprises a central region and a rib positioned theron.

35. A fluid ejection device comprising:
at least one chamber for ejecting fluid through a first opening, the at least one chamber configured to receive fluid from a fluid-feed passageway through a first opening; and,
another opening fluidly coupled to and formed along the fluid-feed passageway, another opening configured to remove air from the fluid ejection device;
wherein the fluid-feed passageway tapers from a first dimension at a location proximate the another opening to a second dimension at a location proximate the second opening.

36. The fluid ejection device of claim 35, wherein the another opening has a minimum dimension measured orthogonally to a bore axis of the another opening that is less than a minimum dimension of the first opening measured orthogonally to a bore axis of the first opening.

37. The fluid ejection device of claim 35, wherein the air purge opening comprises a central region and a capillary region.

38. The fluid ejection device of claim 35, wherein the air purge opening comprises a central region and a rib formed on the central region.

39. A fluid ejection device comprising:
an orifice layer defining at least a first nozzle being configured to eject liquid from the fluid ejection device;
the orifice layer further defining at least a second different nozzle being primarily configured to remove air from the fluid ejection device, the second nozzle comprising a central region and a capillary region.

40. A fluid ejection device comprising:
an orifice layer defining at least a first nozzle being configured to eject liquid from the fluid ejection device;
the orifice layer further defining at least a second different nozzle being primarily configured to remove air from the fluid ejection device, the second nozzle comprising a central region and a rib.
